(19) United States
(12) Patent Application Publication
(10) Pub. No.: US 2011/0078572 A1
(43) Pub. Date: Mar. 31, 2011

(54) SYSTEMS AND METHODS FOR ANALYZING CLICKSTREAM DATA

(75) Inventor: Paul George Milazzo, Hockessin, DE (US)

(73) Assignee: Rovi Technologies Corporation, Santa Clara, CA (US)

(21) Appl. No.: 12/570,778

(22) Filed: Sep. 30, 2009

(51) Int. Cl. G06F 15/173; G06F 3/01

(52) U.S. Cl. 715/733; 709/224

(57) ABSTRACT

Systems and methods are provided for analyzing clickstream data related to consumption of media items by determining whether clickstream data is missing and using information about the time the media was used, characteristics of the media, and user inactivity and activity thresholds.

### BACKGROUND OF THE INVENTION

This invention relates generally to media systems, in particular, to analyzing clickstream data that may indicate status of media guidance related applications and components, and use thereof.

There are numerous types of media devices through which a user may consume media. Many media devices are provided with a media guidance application which may be used to identify and access media items. Some media guidance applications have a capability alone, or in connection with, one or more applications or components to capture and communicate clickstream information. A clickstream is a recording or tracking of user selections or activity, in for example, a media guidance application. Clickstream information may also indicate status and configuration of associated applications or devices. Analysis of clickstream data may be performed to assess media use, including user media preferences, media trends and patterns, audience measurements, use of certain features with the application, device or component utility, and other user media consumption details.

One problem that may be encountered in the capture of clickstream data occurs when a user selection is entered in a media guidance application on equipment or a device that may be operated independently of a device on which the media is displayed. In such an arrangement, when the display device is turned off, the media guidance application may continue to operate and report operation based on user selections previously entered. An example of such a scenario is when a television set is turned off after being tuned to a particular media item using a media guidance application operating on a separate set top box device connected to the television. The media guidance application may remain turned on and will continue to operate and will generate a video signal that is provided to the television while it is off. In this case, even though the user did not watch the media item or channel since the display device is turned off, the clickstream data of the media guidance application may indicate otherwise. Analysis of such clickstream data would provide inaccurate results.

Another problem encountered in clickstream analysis may occur when the media guidance application or other related component fails or provides erroneous clickstream information. For example, if a media guidance application fails to supply periodic or other clickstream information, such omission may indicate incorrect or irrelevant media consumption information.

Accordingly, embodiments of the systems and methods described herein are directed to enhancing analysis of clickstream data and detecting clickstream data problems.

### SUMMARY OF THE INVENTION

There are many types of devices that may be used to consume media items. Examples of such devices may include audiovisual devices, handheld portable devices, computers, televisions, personal communication devices, and other devices capable of presenting or supplying media, including music, television programming, movies, games, news, internet based media content, and other types of media. Media devices are often provided with a media guidance application which may be used to identify and access media items. For example, an interactive media guidance application may be used with a set-top box, television, monitor or other display device for identifying and accessing television programs, interactive games, movies, music, or other types of media. In another example, a media guidance application may provide a user interface for identifying and selecting media items from media providers and suppliers for consumption via a handheld device, computer, telephone, set-top box, television, or other device. User selections entered in the media guidance application may be recorded as clickstream data. Such clickstream data may be stored on the device, or at a remote location, and analyzed on a real time basis, or at a later time, to determine media trends and media device usage.

Although examples described herein are generally discussed in the context of media guidance applications for viewing television programming and movies on a television or other user equipment, these scenarios are only meant to be illustrative. The methods and systems described herein may be applied to any type of media device in which a media guidance application is provided for accessing media content, and which is capable of capturing clickstream information alone or in combination with other related devices.

In an embodiment, systems and methods for analyzing clickstream data are provided in which clickstream data is received that indicates user activity and user inactivity on a media device. The clickstream data typically includes at least a time of the user activity, as well as time and duration of the user's inactivity. Media information may be used to identify a media item associated with clickstream data, as well as a following media item. Examples of media information may include program schedules, and program information. A characteristic of the media item and a following media item may be determined, for example, using program information and program schedules. A variable threshold for user inactivity (or activity) that is based on media item characteristics may be used to infer whether the media item was consumed. Such a threshold may differ from one media item to a following media item, if, for example, the media items have different characteristics. Separately or in combination, a variable threshold for user inactivity based on media item time may also be used to infer whether the media item was consumed. User inactivity thresholds may be based on, for example, a quantity and type of user interactivity, elapsed time between user interactions, elapsed time of inactivity, and a schedule associated with the media item. User activity and inactivity thresholds may be variable and based on third party data, group data, or user data. In some embodiments, clickstream data may be analyzed to determine whether any clickstream data is missing. Missing clickstream data may be identified using data associated with clickstream data, including time and sequence numbers, and clickstream data of control devices.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1-2 show illustrative display screens that may be used to provide media guidance application listings in accordance with one embodiment of the invention;

FIG. 3 shows an illustrative user equipment device in accordance with one embodiment of the invention;

FIG. 4 is a simplified diagram of an illustrative interactive media system in accordance with one embodiment of the invention;

FIG. 5 shows an illustrative click stream data log in accordance with an embodiment of the invention;

FIG. 6A-B shows an illustrative process in accordance with embodiments of the invention;

FIG. 7 depicts a diagram of user selections in reference to a media listing in accordance with an embodiment of the invention; and

FIGS. 8-11 show illustrative processes in accordance with embodiments of the invention.

### DETAILED DESCRIPTION OF EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

Use of a media guidance application, its features, and consumption of media content may be recorded using clickstream information. A clickstream is a recording or tracking of user selections or activity in, for example, a media guidance application. Analysis of clickstream data may be performed to assess media use, including user media preferences, media trends and patterns, audience measurements, use of certain features, device or component utility, and other user media consumption details.

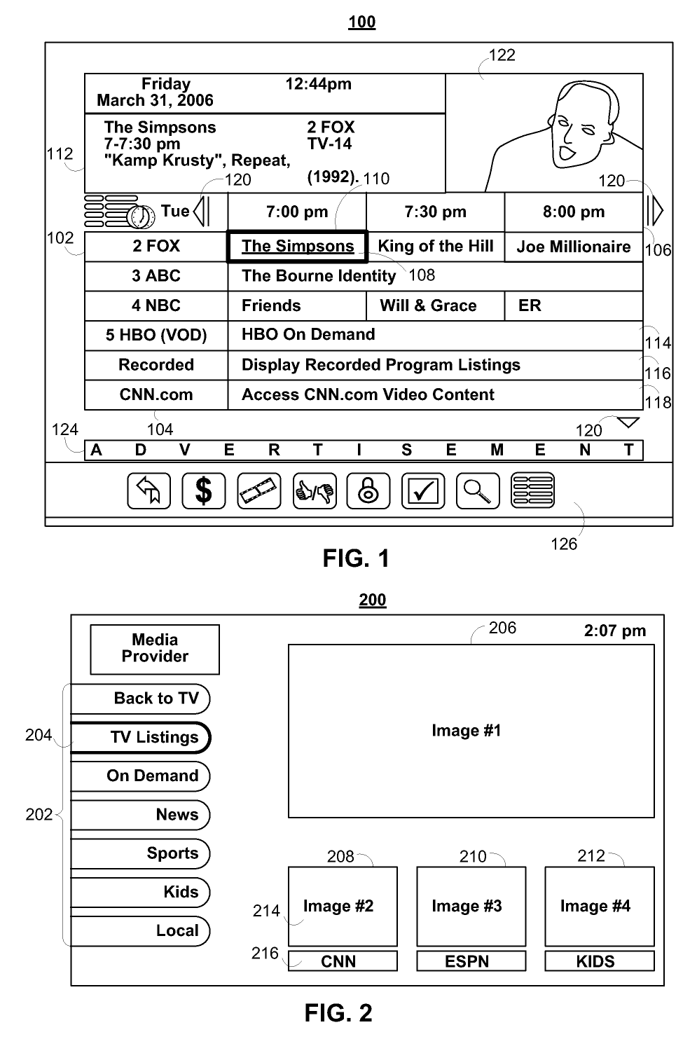

One of the functions of the media guidance application is to provide media listings and media information to users. FIGS. 1-2 show illustrative display screens that may be used to provide media guidance, and in particular media listings. The display screens shown in FIGS. 1-2 may be implemented on any suitable device or platform. While the displays of FIGS. 1-2 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. Selection of such options would be captured as clickstream information by the media guidance application. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.) Information associated with any user indication or selection, such as any media listing, navigational icon or other item in display 100 may be captured as clickstream data.

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options. Selection of these options may be captured as clickstream data.

The media guidance application may be personalized based on a user's preferences. In addition, personalization, preferences, or some customization may be provided for a guest, privacy, and parental control mode. Such personalization and preferences may be captured as clickstream data. A personalized media guidance application allows a user to customize displays and features to create a personalized “experience” with the media guidance application. This personalized experience may be created by allowing a user to input these customizations and/or by the media guidance application monitoring user activity to determine various user preferences. The monitoring may be performed using clickstream information indicating media accessed by user or other user interactions. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. Either may be captured as clickstream data. The media guidance application may, for example, monitor the media the user accesses and/or other interactions the user may have with the guidance application. The monitoring may be performed using clickstream information indicating media accessed by the user or other user interactions. Additionally, the media guidance application may obtain all or part of other user profiles that are related to a particular user (e.g., from other web sites on the Internet the user accesses, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

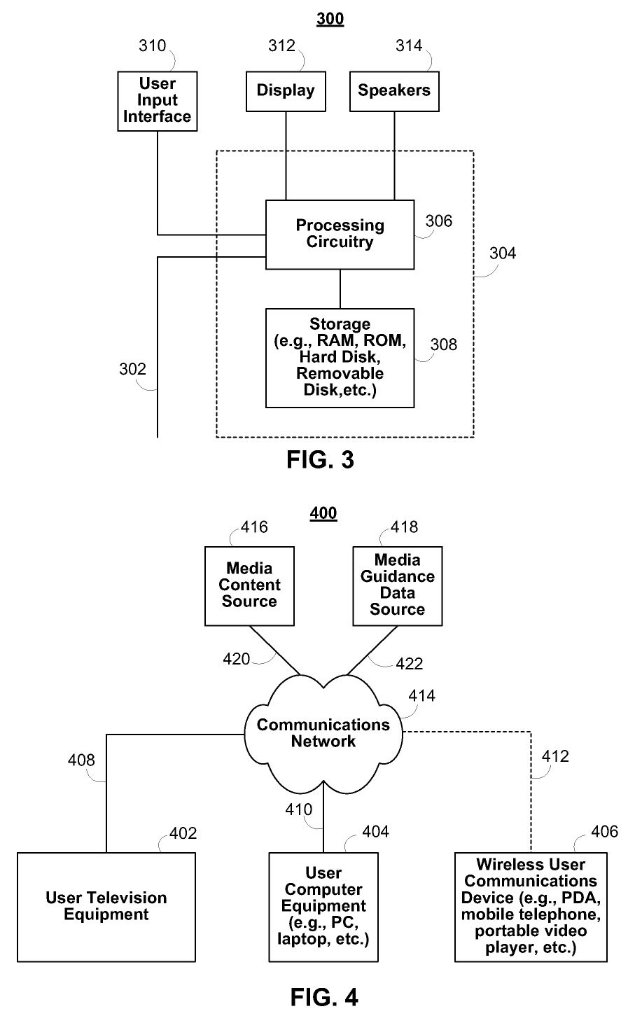

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, clickstream information and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. For example, control circuitry 304 may include communications circuitry suitable for communicating clickstream information to an application server. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, clickstream data, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In this approach, clickstream data may be stored and analyzed locally. In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. In a client-server based application, clickstream data may be transmitted periodically to a remote server for analysis.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices. In any of the guidance application arrangements, clickstream data may be captured and analyzed, as discussed further herein.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets). Clickstream data may be captured for each type of device. In some applications, user-specific clickstream data may be collected across different user device types for user-specific analysis.

The user may also set various settings to maintain consistent media guidance application settings across in-home devices and remote devices. Such settings may be collected as clickstream data. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

As mentioned above, user selections and activity related to and information about a media guidance application may be recorded as clickstream data. In some embodiments, clickstream data may be supplied to a cable system headend, media server, or other component that is configured to receive clickstream data from user equipment 300 or intermediate source for analysis. In other embodiments, clickstream data may be maintained and analyzed locally on user equipment 300. In either arrangement, clickstream data may be processed using control circuitry 306 and stored in storage 308 on a permanent or temporary basis. Clickstream data may include continuous collection of any information relating to user activity. For example, any user input interface entries, such as remote-control key presses, channel changes, navigation and use of media guidance application features, recording information, or other activity may be collected as clickstream data. In addition, clickstream data may also include information about a media guidance application and associated elements. Some examples of such clickstream data may include a periodic health indication, available features, application configuration, element information, or other information about the media guidance application.

The clickstream data may be analyzed as collected and sent to a remote server for analysis. In other embodiments, clickstream data may be processed, for example, using processing circuitry 306, to create data structures or short sequences of data which may be called log entries. The clickstream log entries may be stored in storage 308 or sent via a communications path to a remote storage device. The clickstream log entries may also be sent to a headend or remote analysis facility. When clickstream log entries are analyzed at a remote analysis facility, clickstream log entries may be aggregated from multiple users for analysis. The analysis facility will generally store and process the clickstream logs and log entries and prepare various analytical reports relating to, for example, viewer behavior, advertising impressions, audience measurements, feature usage and popularity, effectiveness of display structures, and other reports.

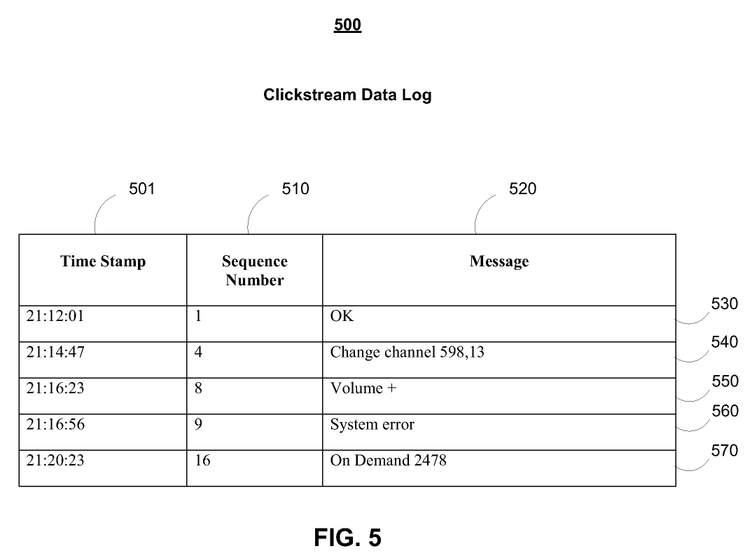

An illustrative list 500 of clickstream logs is presented in FIG. 5. Clickstream logs may include log entries from one or more devices and users. Clickstream logs 530-570 may include an associated time stamp 501, sequence number 510, and the message log 520. Other data items related to clickstream may also be associated with clickstream logs. Clickstream messages 520 may include any clickstream information, such as keystroke inputs, features navigated, channels selected, media viewed, device status, or other information, and may be codes, abbreviations, or combinations thereof.

In some embodiments, only certain types of user activity and guidance application information may be collected as clickstream data. Definitions of such clickstream data may be provided using processing circuitry 306 or other components. In other embodiments, any user activity and guidance application information may be collected as clickstream data. In yet other embodiments, clickstream data may be filtered, for example, by processing circuitry 306, so that some less important information is removed. Filtering may occur at processing circuitry 306, at a remote server, or remote facility using one or more filtering algorithms. Some examples of clickstream information that may be filtered are periodic health status indications that are normal, a routine pulse message, hardware configurations, or other routine message. Devices may be identified for filtering based on random filter assignments, user relative interactivity, information known about devices, such as location, type, user details, and other bases. Constant or consistent filtering algorithms may be used in some embodiments. In other embodiments, filtering algorithms may be provided that change, according to, for example, user interactivity, hardware changes, media changes, or other basis.

In some embodiments, a remote facility arrangement may use combinations of filtered clickstream logs and log entries and unfiltered clickstream logs and log entries. In this arrangement, some designated devices, such as certain user equipment, may send all clickstream log entries which may be used as a reference or benchmark comparison for analysis of filtered clickstream log entries. For example, designated user equipment messages may include a hardware configuration message and system health message that may be used in analysis of filtered clickstream log entries. In particular, a media guidance application configuration message may correlate keystrokes and guide features. For filtered clickstream log entries, such information may be used to determine, for example, what the clickstream recorded keystrokes provide.

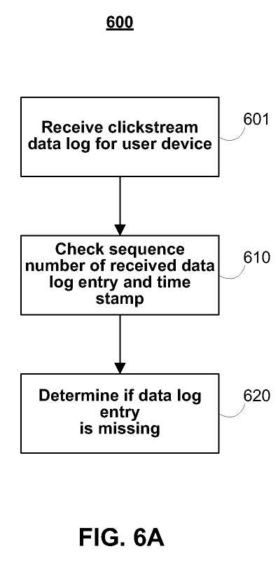

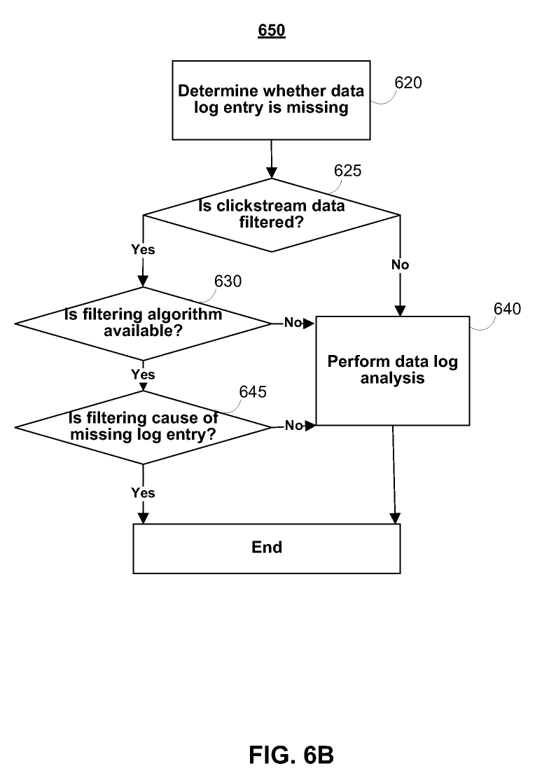

In an arrangement in which filtering is used for clickstream logs, gaps may appear in clickstream log entries, e.g., as those shown in FIG. 5 by the non-sequential sequence numbers 510, which may indicate that certain messages or entries were filtered and omitted. The gaps could also indicate that certain messages were lost. Detection of lost clickstream messages may be provided according to the flow 600 depicted in FIG. 6A.

FIG. 6A depicts an illustrative method for detecting lost clickstream messages or entries. At step 601, a clickstream data log entry or an aggregated log of multiple log entries may be received for one or more user devices. For example, data log entries from one or more user equipment devices 300 may be received at a remote analysis facility. For arrangements in which analysis is provided locally, or at the user equipment, circuitry 306 or other suitable component may be used to process the data log entries which may be received from local storage, such as storage 308. In either arrangement, at step 610 a check of the clickstream message sequence number (e.g., 510 of FIG. 5) and time stamp (e.g. 501 of FIG. 5) may be performed using a processor. The processor, such as processing circuitry 306, a remote server processor, or a remote facility processor, may determine at step 620 whether any clickstream data log entries are missing. Such determination may be performed by comparing the time stamps and sequence numbers and filtering algorithms, further described herein.

Continuing to FIG. 6B, determining whether clickstream data log entries are missing may be performed by checking for filtering algorithms. First, a determination may be made as to whether the clickstream data is filtered at step 625 using a filtering algorithm. This determination may be made by checking data associated with the data log or prior or following log entries that may indicate filtering status. This may also be performed by checking a look up table that may include user information and associated filtering status. If the clickstream data is filtered, at step 630, the filtering algorithm may be requested. Filtering algorithms may be supplied by a remote facility, or the user equipment. In some arrangements, however, the filtering algorithm may not be available or may be unusable. In this case, data log analysis continues, as described below to determine whether a data log entry is missing, at step 640. The determination performed at step 640 may be performed using a processor, such as processing circuitry 306, a remote server processor, or a remote facility processor. If the filtering algorithm is available, it may be used at step 645 to determine whether the data log entry is missing because of a filter setting. If it is the cause of the missing data log entry, the analysis may end. If not, the analysis may continue at step 640.

The determination at step 640 is discussed using the following representative examples. In FIG. 5, there is a sequence gap between message numbers 1 and 4 (530 and 540, respectively). Message 530 is a pulse message that has a generic status message “ok”. If a filtering algorithm removes, for example, each pulse message sent every minute at :01 seconds, then a message 2 sent at 21:13:01 and a message 3 sent at 21:14:01 would have been filtered prior to message 540 sent at 21:14:47. Since these message may have been purposefully omitted, the processor may determine that the missing messages 2 and 3 were not lost, and instead were merely filtered. For the gap between messages 540 and 550, message sequence numbers 5-7 are missing. Using the same filtering algorithm, a message 5 would have been sent at 21:15:01, and message 6 at 21:16:01. Since message 8 (550) was logged at a time before a pulse message 7 would have issued, the processor would determine whether there was a message 7 that is missing. Similarly for the gap between message 9 (560) and message 16 (70), by comparing expected filtered messages, the processor may determine that several messages are missing. Missing messages may also be identified by checking a time stamp and comparing it to the sequence number. Clickstream data log entries may also provide an indication of a missing log entry. For example, for a message that indicates a repeating or constant problem, the omission of an initial message about the problem may indicate that a log is missing. As would be understood by one of skill in the art, any filtering algorithms may be used for filtering clickstream data, and accordingly, detection of missing clickstream log entries may be provided using comparison of such filtering algorithm.

Another way in which a missing clickstream message log entry may be detected is by use of clickstream data log entries and logs from designated devices. Such devices may be considered control or canary devices which transmit all clickstream log entries without filtering. Canaries or designated devices may be selected randomly, or based on some user or hardware information. Such devices may be permanently designated as not having filtered clickstream data, other devices may be temporary canaries. By comparing logs of such a device with logs from a filtered device, a processor may determine whether log entries are missing, and replace those missing clickstream log entries using the corresponding data log entry or part thereof from the control devices.

Aggregating clickstream data from multiple user devices may be useful in identifying media consumption trends. For example, certain trends may be identified for user activity and relative inactivity with respect to certain types of media or features. In particular, while viewing an evening news item, a user may enter multiple inputs, such as channel changes during advertising. The same user may enter fewer inputs while viewing a daytime drama. The user may also enter few inputs while watching an evening drama, etc. Such information may be aggregated to identify trends with respect to media types. Other trends may be identified for media consumption at different times of day. For example, daytime media items may be viewed with fewer user selections and interactions than for evening broadcasts. In addition, certain user activity or inactivity may be associated with such media consumption. For example, in the evening, viewers of sports or news related media may input many key selections, such as mute, channel changes, etc. In contrast, viewers of daytime dramas or premium movie channels without advertisements may input relatively few key selections. These trends may be aggregated based on group data, individual users, as well as selected cohorts which may be a subset of a group that has similar viewing behavior.

These and other trends may be used to analyze clickstream data that indicates user activity and inactivity for certain media types with greater accuracy. One underlying assumption in analyzing clickstream data is that a viewer is present and consuming the media identified in the clickstream data. However, since many television viewers never turn off their set top boxes, this assumption may not always be true. If a set top box is turned on and tuned to a particular channel or media item, and the display device is turned off, clickstream data indicating the particular channel or media item may continue to be generated by the set top box. Since the viewer is not actually viewing the media item, analysis based on such clickstream data would provide inaccurate information. For example, audience measurements for media items and advertisement impressions based on such clickstream data would be incorrect. In some conventional systems, a time based assumption may be used to establish viewer presence. For example, a clickstream algorithm may require that some user activity occur at least every two or three hours. In the absence of any user activity after such a time threshold, the viewer may be determined to be idle. Such an approach, however, would potentially designate as idle a viewer of a long movie. This approach may also inflate audience measurements for the two or three hours of programming following a viewed item. In some embodiments, a viewer may be tested to determine whether they are viewing the item. For example, a message may appear on the display device asking for an input to continue, or volume or brightness of the device may gradually change, for example to a lower volume or dimmer screen until it is essentially inaudible and/or unviewable. An interactive advertisement or promotion may be provided to see if a user will interact with the advertisement or promotion. Other tests may be used to cause a user to interact with the device.

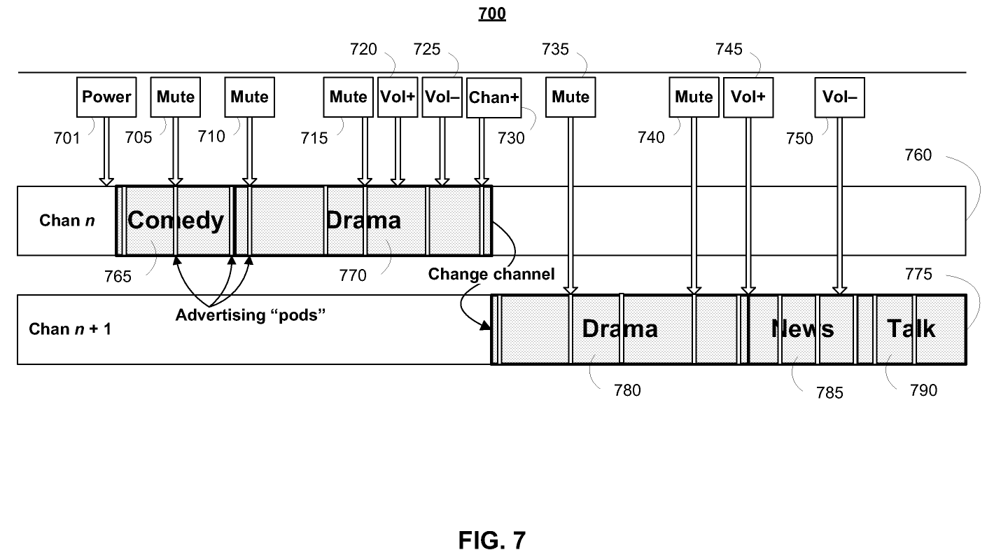

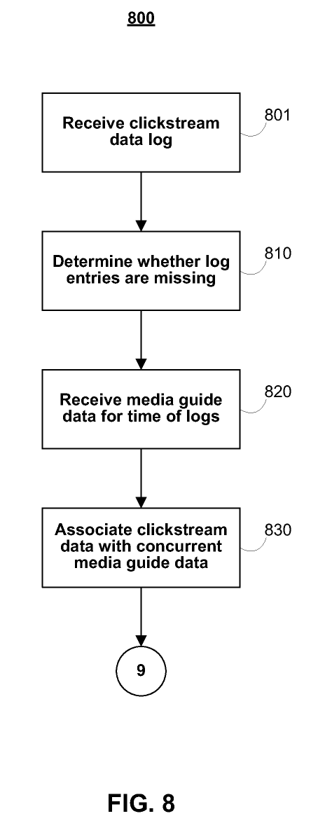

An example of user activity is depicted in FIG. 7. As shown, a user may turn on user equipment using a power key selection 701 by accessing the guide. A tuner or other component may tune to or stream Channel n 760 to view a comedy 765 or other media item for display on the display device. At certain intervals a mute selection may be entered 705 and 710. These selections may be during advertising, or other time. As time passes, another media item, such as drama 770 may begin. The user may continue to enter key selections 715-730. All or some of the user selections may be recorded as clickstream data. The clickstream data may be associated with media type and user type to ascertain common user activity, such as use of muting and volume changes, while viewing. A viewer may continue viewing media content and change channels to 775 to watch drama 780. Such a selection would be recorded as clickstream data, as would user activity 735-750 during viewing of media items 780-785. Since no user activity is entered during item 790, it is not immediately clear whether a viewer is viewing item 790. Such a determination may be performed following the steps of the flowcharts depicted in FIGS. 8-10

Turning to FIG. 8, clickstream data log entries or aggregated logs may be received at step 801. As described previously, the data logs or log entries may be received locally at user equipment 300 for analysis or sent to a central analysis facility. A determination may be made at optional step 810 as to whether any log entries are missing. Step 810 may be performed following the steps described with reference to FIG. 6A. Media guide data for the clickstream data logs may be received at step 820. Examples of media guide data include program listing information, program schedules, advertising schedules, and other data. Media guide data, may be received from several sources, including media content source 416 or media guidance data source 418. Other guide data sources may also be used. The media guide data may be used to correlate clickstream data and media types at step 830. For example, as shown in FIG. 7, certain types of user activity muting of advertisements, increasing volume during a news item, or other correlations may be made. In addition, user relative inactivity, such as during a drama 780, may also be used to correlate clickstream data and media types. The media guide data can also be used to correlate a time aspect of clickstream data. For example, schedule information may indicate that a new media item, e.g., a talk show 790 (FIG. 7) began after media items in which the user entered various selections 701-750. Other types of media data may also be used to enrich this process, such as other non-user specific audience generated content that may bear on user activity while consuming content. For example, other aggregated data from third party surveys, user surveys, and other information may be used. In addition, trend information for user activity may also be used in correlating clickstream data and guide data.

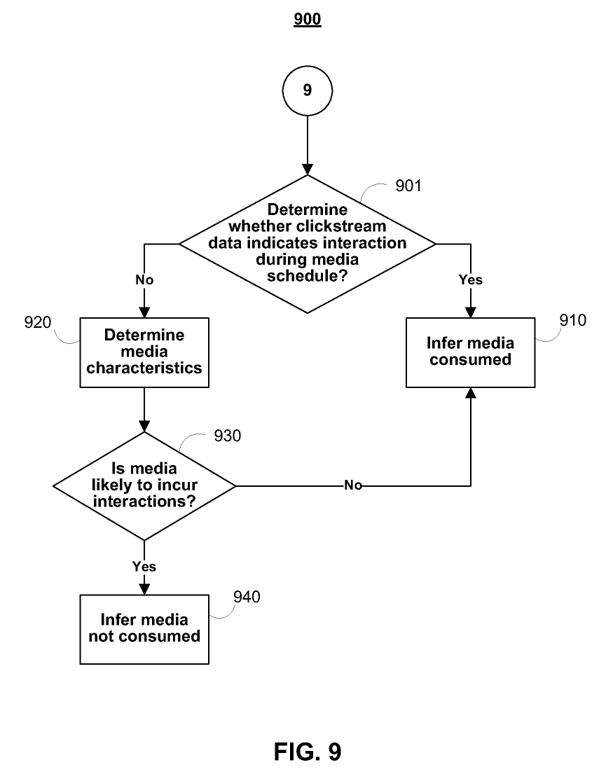

Turning to FIG. 9, when clickstream data and media guide data is received (e.g., following FIG. 8), a determination of whether media has been consumed may be performed following the steps of flowchart 900. The determinations may be performed using user equipment processing circuitry, or at a remote central analysis facility. An initial determination may be performed at step 901 as to whether clickstream data indicates interaction or user activity during scheduled media. The determination at step 901 may be performed by comparing clickstream data and a concurrent media schedule or availability information. A grace period may be applied so that media information may be used for media that is scheduled prior to and after the time of the user activity. This may be useful when a user selects a media item at a time preceding a scheduled broadcast, and then does not interact with the user equipment.

If it is determined that clickstream data occurs during scheduled media, then an inference may be made that the media has been consumed, at step 910. If, however, no interaction or user activity is determined to occur during scheduled media, at step 920, information or characteristics about the scheduled media may be determined. For example, if clickstream data for a certain time indicates that user equipment is turned on and tuned to a particular media source, but no additional user activity is detected, information about the media source may be identified, including the available media and any characteristics. For example, media that is determined to be sports related may typically be watched by certain types of viewers and typically have more user activity than news related media. In another example, day time drama media may have fewer user interactions than an evening comedy.

Information associated with such characteristics may be used to determine whether the scheduled media is likely to incur user interactions at step 930. If the media is determined to be a type that typically incurs interactions, an inference may be made that the media was not consumed at step 940. If, however, the media is determined to be a type that typically does not incur transactions, then an inference may be made that the media was consumed at step 910. Inferences for media consumption may be based on a comparison of user interactions and a user interactivity and user inactivity threshold, further described herein.

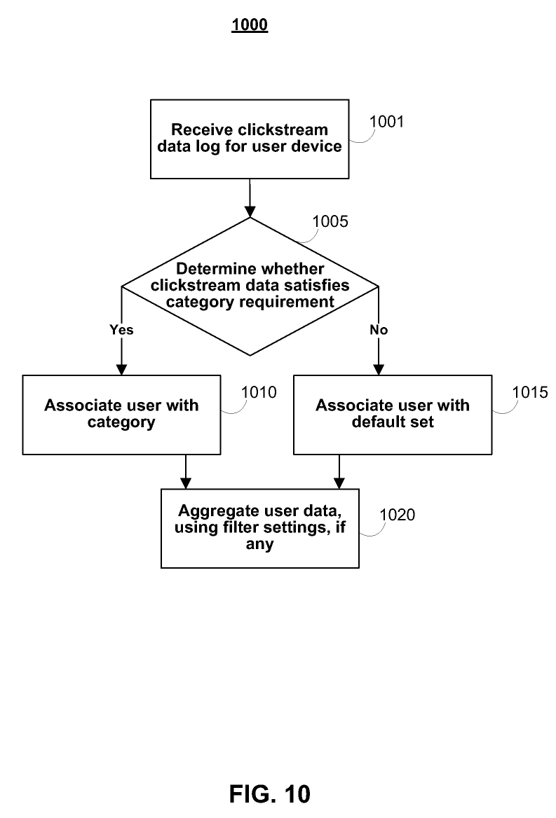

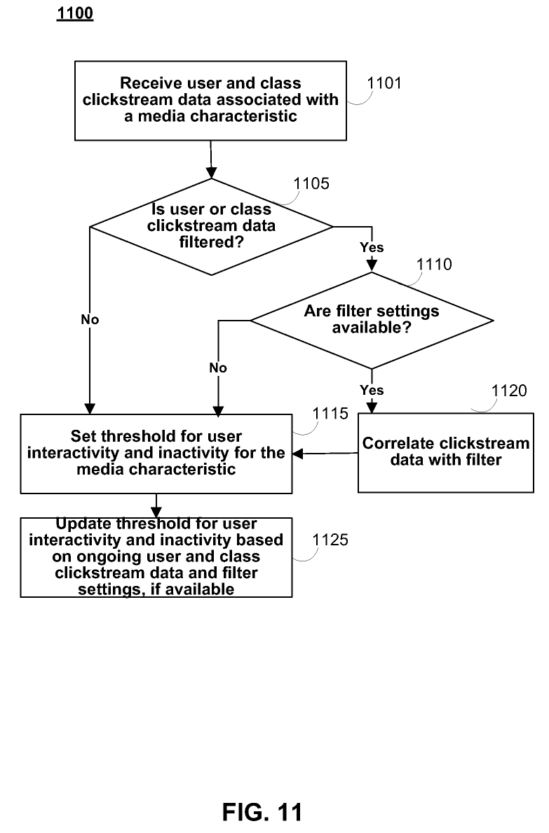

The above mentioned determination at step 930 may be made using analysis that may be performed according to FIGS. 10-11. FIG. 10 depicts a flow for aggregating user clickstream data. At step 1001, clickstream data logs or log entries may be received by processing circuitry or a remote facility for determining. The clickstream data may be analyzed to determine whether the clickstream data satisfies any categories or group requirements at step 1005. For example, the clickstream data may be analyzed to determine whether it includes indications of certain types of media consumption patterns. For example, clickstream data indicating a lot of any type of user interactivity may be useful for determining certain general patterns. Such a user may be associated with a relevant category at step 1010 for later analysis. Associations may be provided using relational groupings stored in a database accessible by a remote processing facility. If user clickstream data does not satisfy any categories, the user may be associated with a default set at step 1015. Other examples of user categories may include clickstream data indicating a high volume of certain genres of media, such as sports, dramas, on-demand content, news, etc. In addition, geographical information or other user related information may also be used to establish groups. Each individual user may be included in one or more groups or categories. Clickstream data for users in the group may be aggregated at step 1020. If filter settings for the clickstream data is known or available, it may be used to further refine the clickstream data.

The categories, as well as individual user media behavior may be used to create activity and inactivity thresholds for clickstream analysis. This may be continuously updated using real time data, using, for example, the flow 1100 of FIG. 11. At step 1101 clickstream data for users and/or classes, categories or groups of users may be associated with media characteristics. Such associations may be performed, generally, by a remote analysis facility. For example, certain types of user interactivity may be associated with a certain types of media characteristics and a time in which such media is consumed. A determination may be made at step 1105 as to whether the clickstream data is filtered. If it is, the filter settings may be requested from a filter provider, the user equipment or other source, at step 1110. The filter settings, if available, may be used by processing circuitry to correlate the clickstream data at step 1120, for example, by creating any clickstream data that may have been removed by the filter. Such correlated data may be used to set threshold user activities at step 1115, further described below. If the filter settings are not available, or if the clickstream data is determined to have not been filtered, the clickstream analysis continues at step 1115.

At step 1115, a threshold for user activity and user inactivity for a certain type of media characteristic may be established. In an example, for a channel having similar content as was previously viewed, a threshold for similar types of user activity may be used. In another example, for sports related media, a relatively high threshold of user activity may be set, as well as a relatively low threshold for user inactivity, while for a movie provided in a premium advertisement-free format, a threshold for user activity may be relatively low, and a threshold for user inactivity may be relatively high. Other combinations of media characteristics and threshold may be associated and changed as would be understood by one of skill in the art. At step 1125, such thresholds may be updated and revised based on ongoing clickstream analytics.

The above described embodiments of the present invention are presented for purposes of illustration and not of limitation, and the present invention is limited only by the claims which follow.

What is claimed is:

1. A method for analyzing clickstream data, the method comprising:
receiving clickstream data indicating user activity of a media device, wherein the clickstream data comprises at least a time of a user activity;
receiving media information indicating a first media item associated with the user activity at the time of the user activity;
determining a characteristic of the first media item; and
using a variable user inactivity threshold associated with the characteristic of the first media item, the time of the user activity and the information indicating the first media item associated with the user activity at the time of the user activity, to determine whether the first media item was consumed.

2. The method of claim 1 wherein the variable user inactivity threshold is based on a quantity and type of user interactivity, elapsed time, and a schedule associated with the media item.

3. The method of claim 1 wherein the variable user inactivity threshold is based at least in part on third party data, group data, or user data.

4. The method of claim 1 further comprising receiving media information indicating a second media item, wherein the second media item follows the first media item; determining a characteristic of the second media item; and using a second variable user inactivity threshold associated with the characteristic of the second media item to determine whether the second media item was consumed.

5. The method of claim 1 further comprising comparing the clickstream data time and a sequence number associated with the clickstream data, and clickstream data from a control device to determine whether any clickstream data is missing.

6. The method of claim 1 further comprising receiving a filter setting for correlating clickstream data.

7. A system comprising user equipment for accessing media items and coupled to a remote processing facility operative to:
receive clickstream data indicating user activity of a media device, wherein the clickstream data comprises at least a time of a user activity;
receive media information indicating a first media item associated with the user activity at the time of the user activity;
determine a characteristic of the first media item; and
use a variable user inactivity threshold associated with the characteristic of the first media item, the time of the user activity and the information indicating the first media item associated with the user activity at the time of the user activity, to determine whether the first media item was consumed.

8. The system of claim 7 wherein the variable user inactivity threshold is based on a quantity and type of user interactivity, elapsed time, and a schedule associated with the media item.

9. The system of claim 7 wherein the variable user inactivity threshold is based at least in part on third party data, group data, or user data.

10. The system of claim 7 wherein the remote processing facility is further operative to: receive media information indicating a second media item, wherein the second media item follows the first media item; determine a characteristic of the second media item; and use a second variable user inactivity threshold associated with the characteristic of the second media item to determine whether the second media item was consumed.

11. The system of claim 7 wherein the remote processing facility is further operative to: compare the clickstream data time and a sequence number associated with the clickstream data, and clickstream data from a control device to determine whether any clickstream data is missing.

12. The system of claim 7 wherein the remote processing facility is further configured to receive a filter setting for correlating clickstream data.
